(19) United States
(12) Patent Application Publication
(10) Pub. No.: US 2006/0007317 A1
(43) Pub. Date: Jan. 12, 2006

(54) Method for displaying remote images

(76) Inventor: Rehn-Lieh Lin, Chutung Town (TW)

Correspondence Address: HARNESS, DICKEY & PIERCE, P.L.C., P.O. BOX 828, BLOOMFIELD HILLS, MI, 48303, US

(21) Appl. No.: 10/886,499

(22) Filed: Jul. 7, 2004

(51) Int. Cl. H04N 5/232; H04N 9/74; H04N 7/18; H04N 9/47; H04N 5/222

(52) U.S. Cl. 348/211.3; 348/143; 348/333.05

(57) ABSTRACT

A web camera is installed for monitoring a place, and the web camera is connected to Internet or Intranet. A browser is utilized for accessing the web camera to monitor the place. The browser reads a series of video images captured by the web camera and respectively displays these video images in different areas according to instructions embedded in a homepage. Oldest images are replaced with new coming images. Even with low data rate in the net, users are still able to monitor the place easily and clearly.

### FIELD OF THE INVENTION

The present invention relates to a method and a system for displaying remote images, and more particularly to the method and the system reading in the remote images from video-capturing tools via a network.

### BACKGROUND OF THE INVENTION

Nowadays, due to the progress of the electronic and network technologies, various applications can be briefly achieved via simple electronic devices, network and computers. For example, remote images can be read in by using a low-cost web cam installed on a TCP/IP Ethernet via a computer, PDA or mobile phone.

The aforementioned remote video system can have a lot of different applications, such as the security monitoring of factory, company, office building, home or parking lot. Besides, such a remote video system also can be applied in providing remote communication of dual or multiple directions for making up the audio deficiency of telephone, thereby holding a teleconference.

However, video data generally occupy quite a huge amount of data space, not only a lot of data are needed for each image to record its image information, but also a lot of images have to be displayed in a short period for taking advantage of the conventional theory of persistence of vision to show an animation effect.

With respect to the huge amount of vision data, although a lot of conventional skills have been developed for reducing the storage and transmission amounts of vision data, yet these efforts all have certain limits. Besides, in the compression skills of reducing vision data, many of them actually sacrifice vision quality or perform destructive compression, such as the conventional MPEG specification.

Moreover, on the remote video applications, the treatment of the video data has become a critical issue, since strict bandwidth restriction or irregular network jam often occurs if the video data are transmitted through Internet or a telecommunication network, wherein strict bandwidth restriction or irregular network jam effects the number of images transmitted in a unit of time.

If another new method can be applied on the top of existing network and file compression skills to resolve the aforementioned problem, then great influence will be generated for promoting the remote video applications.

### SUMMARY OF THE INVENTION

Therefore, one object of the present invention is to provide a method for displaying remote images, such as the method for monitoring images.

Further, another object of the present invention is to provide a remote video system for conveniently providing vision display effect.

Further, another object of the present invention is to provide a video-processing apparatus for receiving images captured by one or more video-capturing tools.

Further, another object of the present invention is to provide a method for displaying a plurality of continuous images.

Further, another object of the present invention is to provide a computer program installed in a memory medium for a computer processor to read in and execute so as to achieve the jobs of processing and displaying the plurality of continuous images.

According to an embodiment of the present invention, a method for displaying remote images is to reading continuous monitored images via a network. The monitored images are respectively displayed in sequence on different display areas of screens or various display apparatuses. A new image covers the area occupied by the old image. Hence, even with the limited network bandwidth or the network jam, a user will not be forced to renew the display area for generating vision effect, thus avoiding the unclear site monitoring caused by the renewal of the display area.

According to an embodiment of the present invention, a remote video system has at least one video-capturing tool, at least one screen and a video-processing apparatus. The video-capturing tool captures a series of images in accordance with a time sequence, and transmits the series of images to the video-processing apparatus via a network. The video-processing apparatus divides a total display area of the screen into a predetermined number of individual display areas. Further, when the video-processing apparatus receives the images from the video-capturing tool, the images are displayed on different individual display areas in a certain sequence. Since the individual display areas are limited to a certain number, the oldest image is covered and replaced by the newest image.

Further, the video-processing apparatus provides an operation interface, so that a user can determine the number of the individual display areas, wherein the aforementioned individual display areas or one single individual display in a continuous mode are/or is used to display the images. Besides, the user also can assign the video-capturing tool to be connected via the operation interface.

According the aforementioned description, the present invention actually provides an effective solution for a remote video system. The present invention can be implemented on various infrastructures, and provides a video-display interface for the user to conveniently observe and monitor the remote images. Particularly, web network jam or insufficient bandwidth occurs, the performance of the present invention will be more appealing.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a system structural diagram in accordance with a preferred embodiment of the present invention;

FIG. 2 is a schematic structural diagram showing an implementation of a video-capturing tool;

FIG. 3 is a system structural diagram showing the other implementation of the present invention;

FIG. 4 is a schematic structural diagram showing an implementation of a video-processing apparatus;

FIG. 5 is a schematic software structural diagram of the implementation of the video-processing apparatus;

FIG. 6 is a flow chart showing the method of the present invention;

FIG. 7(a) shows an exemplary implementation; and

FIG. 7(b) shows the other state of FIG. 7(a).

### DETAILED DESCRIPTION OF THE PREFERRED EMBODIMENT

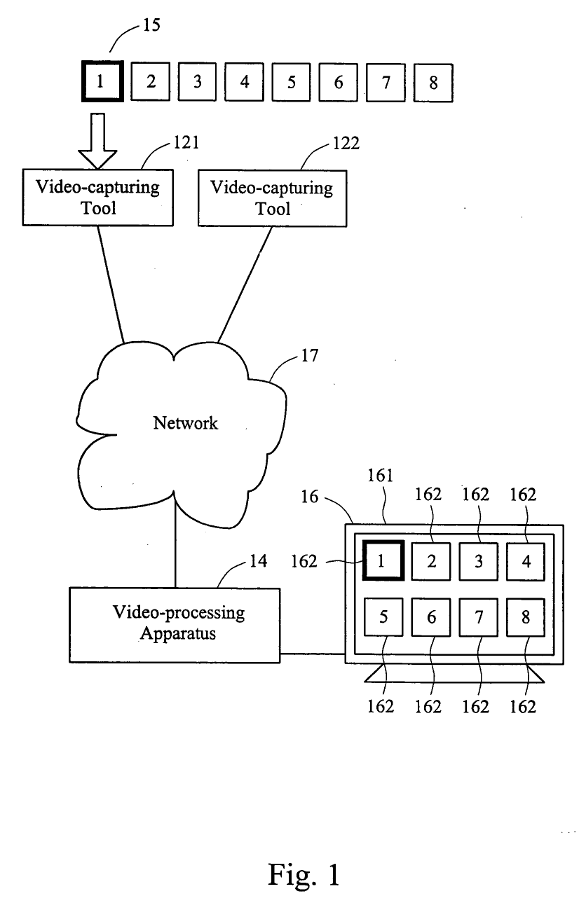

Referring to FIG. 1, FIG. 1 is a system structural diagram in accordance with a preferred embodiment of the present invention. A remote video system 10 has one or more video-capturing tools 121 and 122, a video-processing apparatus 14 and a screen 16. The video-processing apparatus 14 is connected to the video-capturing tools 121 and 122 via a network 17 for exchanging data. The network 17 can be Internet, Intranet or any kind of wired or wireless network.

The video-capturing tools 121 and 122 are used to capture images 15. In this embodiment, the images are labeled with Arabic numerals 1 to 8 in time sequence. The video-capturing tools 121 and 122 can be such as the camera apparatuses made by the technologies including CCD and CMOS. Further, the video-capturing tools 121 and 122 also can be the apparatus that is the combination of a common video camera (such as V8) and a common computer, wherein the images taken by the video camera are input to the computer via an AV terminal.

After capturing the images, the video-capturing tools 121 and 122 send the images to the video-processing apparatus 14 in an active mode or a passive mode. The so-called active mode means that the video-capturing tools 121 and 122 transmit the captured data directly to the video-processing apparatus 14, such as unit cast, multicast or broadcast pattern. Besides, the so-called passive mode means that, after receiving a request from the video-processing apparatus 14, the video-capturing tools 121 and 122 reply the request and transmit the captured data via the network 17 to the video-processing apparatus 14 which making the request, i.e. a client-server architecture.

The video-processing apparatus 14 is an electronic apparatus, such as a computer, PDA or mobile phone or any customized electronic apparatus, etc. installed with an operating system and special application programs. The video-processing apparatus 14 also uses the screen 16 to display the images captured by the video-capturing tools 121 and 122.

Further, while displaying the images, the video-processing apparatus 14 at least performs the following two steps. At first, a total display area 161 is divided into a predetermined number of individual display areas 162, and then the video-processing apparatus 14 places the images with time sequence on different individual display areas 162.

For example, the total display area 161 of the screen 16 shown in FIG. 1 is divided into eight individual display areas 162 used for respectively showing the images at different time spots. Certainly, since the screen 16 can be merely divided into a limited number of the individual display areas 162, the newest image received has to be shown on the individual display area 162 used by the oldest image, i.e. while an image labeled with “9” is received, then the image labeled with “9” is placed to cover the image originally labeled with “1”.

Meanwhile, for letting users know which individual display area 162 is the newest image shown thereon, a vision scheme is added, such as the method of adding a red frame to the individual display image 162 showing the newest image; or adding an arrow, flashing mark thereto.

Hereinafter, the implementations of the video-capturing tools 121 and 122, and the video-processing apparatus 14 will be further explained.

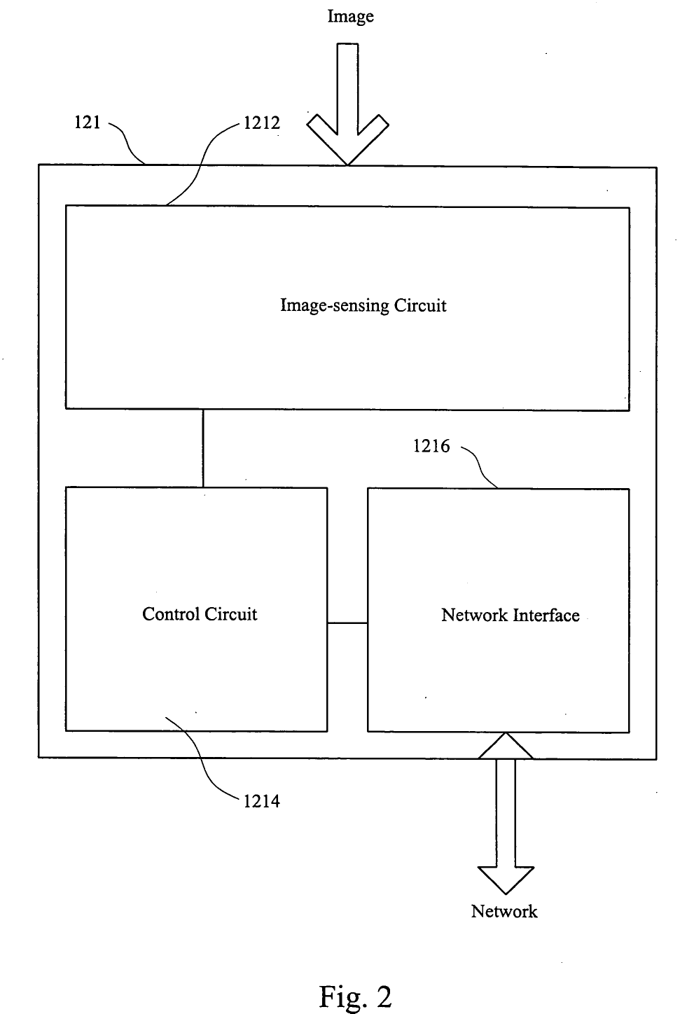

At first, referring to FIG. 2, FIG. 2 is a schematic structural diagram showing an implementation of a video-capturing tool 121. The video-capturing tool 121 has an image-sensing circuit 1212, a control circuit 1214 and a network interface 1216. The image-sensing circuit 1212 obtains a series of images continuously, and sends these images to the control circuit 1214. The control circuit 1214 sends the images to the network 17 via the network interface 1215 so as to further send to the video-processing apparatus 14.

In order to display the received images to the users, the video-processing apparatus 14 needs to use a program code or circuit driver to drive the screen for accomplishing the display job. However, it is not necessary to store the program code in advance in the video-processing apparatus 14. For example, script (such as Java Script, VB Script) program or any other program executable in a browser environment (such as Java Applet) can be stored in a remote apparatus in advance, and then downloaded to the video-processing apparatus 14 via the network 17 if needed.

Under this situation, the program code even can be stored in the control circuit 1214. For example, a web server can be implemented in the control circuit 1214 by means of hardware, software or hardware/software combined. The web server has a file-providing interface (such as HTTP), and has the web page containing the program code. At this time, a common computer with a browser can be briefly used as the aforementioned video-processing apparatus. When the computer is connected to the network and a website address such as http://cameral.placeA.com.tw, or an IP address such as http://192.168.1.14 is entered in the browser, the web page and the program code contained therein can be downloaded. Thereafter, by using the program code, the images can be displayed on the display area of the browser arranged in time sequence in accordance with the aforementioned method.

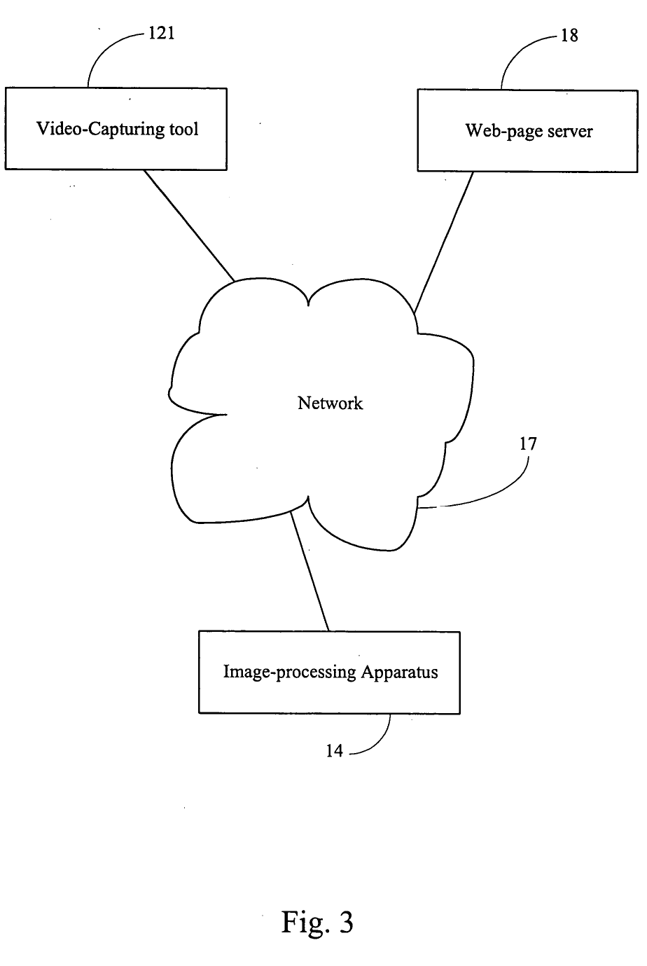

Certainly, the program code can be stored in a device other than the video-capturing tool 121. For example, referring to FIG. 3, FIG. 3 is a system structural diagram showing the other implementation of the present invention. In this implementation, the video-processing apparatus 14 downloads the aforementioned web page containing the program code from the web server 18 via the network 17. After the web page is downloaded, the video-processing apparatus 14 uses the program code to communicate with the video-capturing tool 121, thereby obtaining the image data and displaying the images in accordance with the aforementioned method.

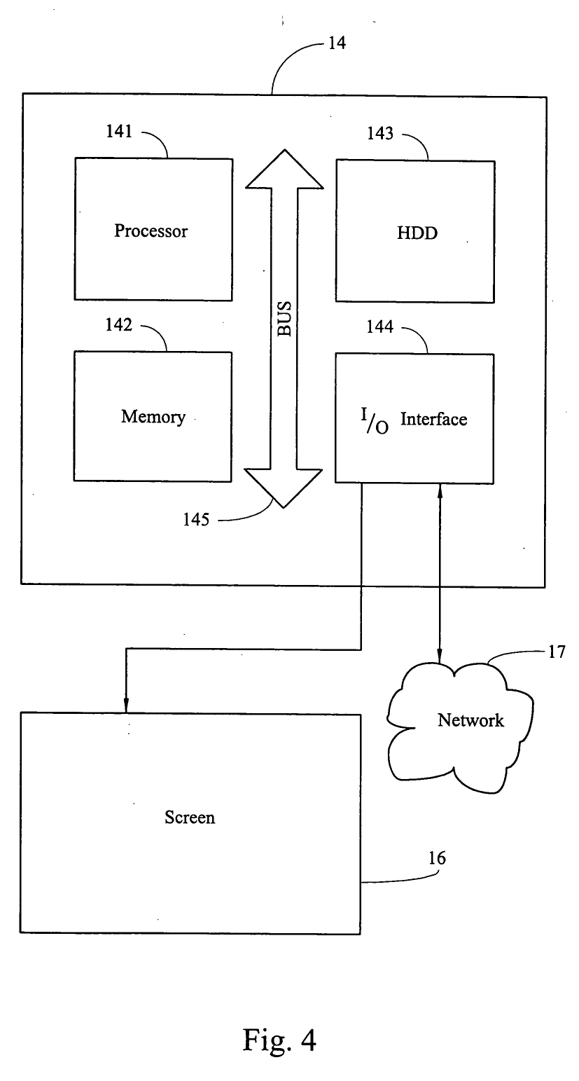

Referring to FIG. 4, FIG. 4 shows an implementation of the aforementioned video-processing apparatus by using common computer architecture. The video-processing apparatus 14 has a processor 141, a memory 142, a hard disk drive (HDD) 143, an I/O interface 144, and a bus 145 for exchanging data among the elements previously described. The I/O interface 144 also functions as a connection between the screen 16 and the network 17.

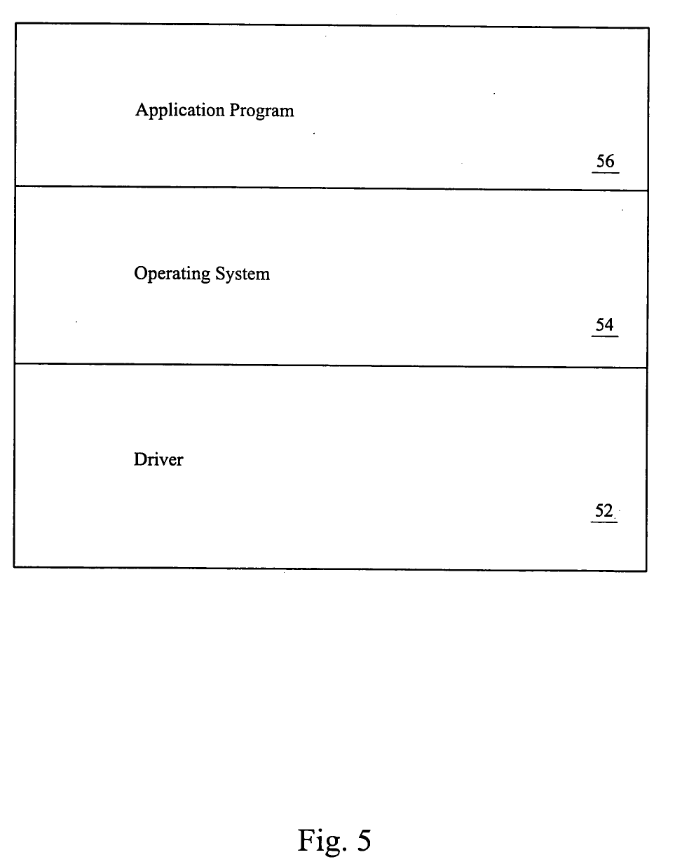

Referring to FIG. 5, FIG. 5 is a schematic software structural diagram of the video-processing apparatus 14. Ordinarily, the software programs are stored in the HDD 143, and the processor 141 loads the required data to the memory 142 for executing the relation operations. A driver 52 is located at the bottom of the system for providing basic capabilities of communicating with the network 17 and the screen 16. Further, an application program 56 in charge of displaying the aforementioned images calls the interface via an operating system 54, thereby accomplishing the related operations.

Further, although a single-screen output is used as an example described above, yet the present invention is not limited thereto. As long as the operating system can provide the support of multiple-screens output, the aforementioned individual display areas can certainly be arranged on the multiple screens. Even if the operating system 54 does not provide direct support, the application program 56 still can drive the screen of another computer via the network 17 so as to bring up the required display areas. Accordingly, the size limitation of the display area shown by one single screen can be overcome.

Further, the implementation of the video-processing apparatus 14 is certainly not limited to the aforementioned architecture, and the related program code or circuit logic also can be implemented by various conventional methods. Hence, the present invention can be concluded and explained with one method.

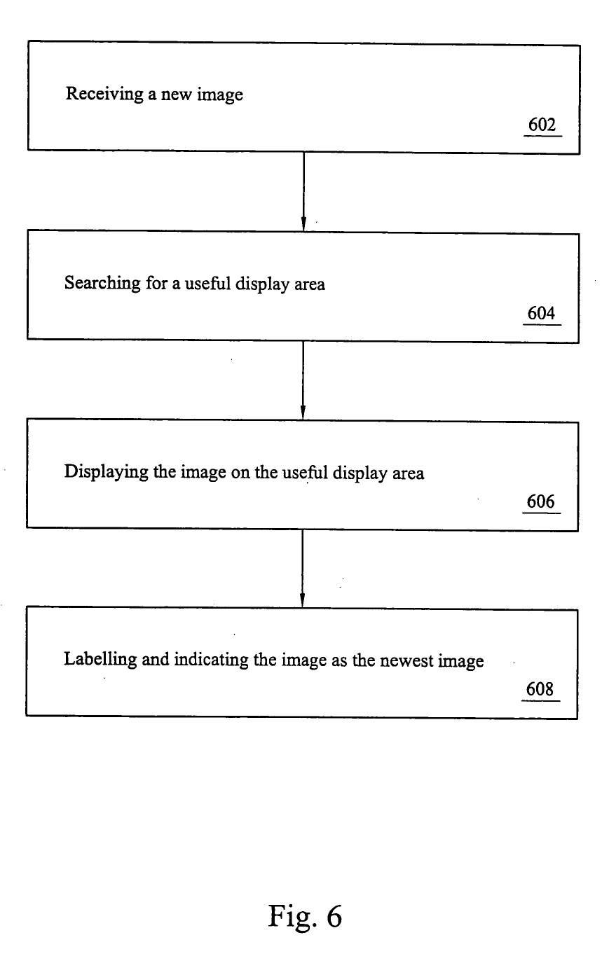

Referring to FIG. 6, FIG. 6 is a flow chart showing the method of the present invention. At first, step 602 is performed for receiving a new image via a network. Then, step 604 is performed for searching for a useful individual display area, such as the individual display area on which the oldest image is originally stored. Thereafter, step 606 is performed for displaying the new image on the useful individual display area. For letting the users easily recognize which individual display area shows the newest image, step 608 is performed for adding the visual label to the individual display area showing the newest image.

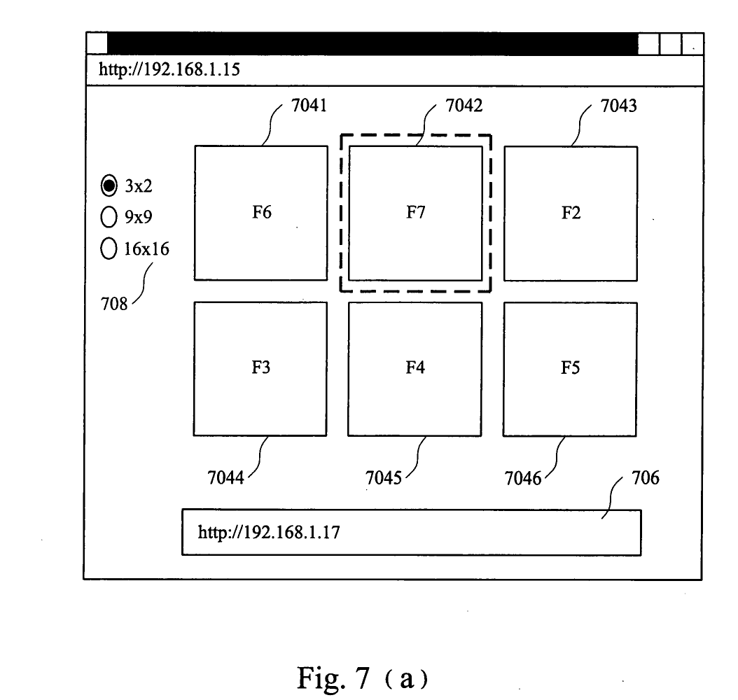

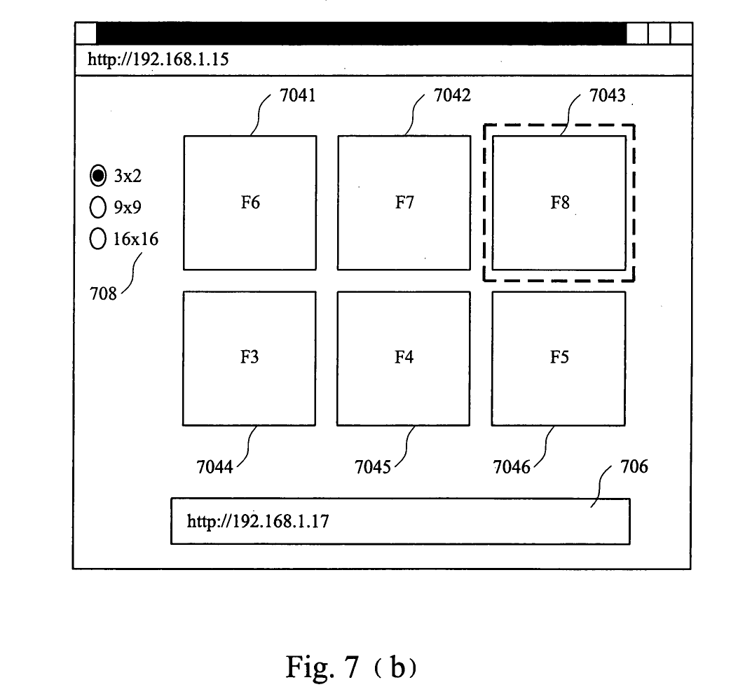

FIG. 7(a) shows an exemplary implementation; and FIG. 7(b) shows the other state of FIG. 7(a). Referring to FIG. 7(a), a user enters a website address (192.168.1.15) of a web page containing the program code in a website address bar 702 of a browser. Then, the browser parses the program code and captures a series of images in accordance with the program code. Thereafter, the browser shows the images sequentially on different individual display areas 7041-7046 in accordance with the program code. Meanwhile, the individual display area 7041 is marked with a visual label so as to represent that the image F7 is the newest image. Further, after receiving the subsequent image F8, the image F8 is placed to cover the oldest image F2, and the visual label is moved thereto.

Further, in this embodiment, operation interfaces 706 and 708 are also provided, so that the user can use the operation interface 708 to determine the number of the individual display areas to be divided from the main display area of the screen. Further, the user also can use the operation interface 706 to designate different video-capturing tools.

Meanwhile, although the aforementioned implementation methods provided by the present invention simply use different individual display areas to show the images of different time spots, yet the present invention is certainly applicable to continuously displaying the images in one identical area. For example, the user can determine via an operating interface either the aforementioned multiple display areas are adopted for showing the images or one single display area is adopted for continuously displaying the images. Certainly, the present invention also can add a judging scheme to the program code or circuit logic, wherein one single display area is adopted for continuously displaying the images when the network speed is higher than a predetermined value; and multiple display areas are adopted for showing the images of different time spots while network is jammed.

To sum up, the present invention can cleverly combine and utilize the existing hardware structure to provide an effective and flexible solution for a remote video system, and the present invention at least has the advantages described below. Firstly, the present invention can use the aforementioned browser architecture, and thus merely needs to write descriptive codes or rewrite the web page to achieve the features of the present invention. Secondly, the present invention also can use the aforementioned manual or automatic adjusting scheme, so that the method of multiple display areas is used to show the images while network is jammed; and the method of one single display area is used to continuously show the images while network is running smoothly, thus having quite a lot of flexibility. Besides, by using the image-displaying method of the present invention, the images still can be clearly seen even under the environment of slow network speed. A user further can compare the minute differences between two consecutive images, thus showing the existing frame-freezing problems more apparently.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for displaying remote images, said method comprising:
sequentially reading in a plurality of continuous remote images;
dividing a main display area into a plurality of individual display areas; and
displaying said continuous remote images respectively and sequentially on said individual display areas.

2. The method of claim 1, wherein said step of reading in said continuous remote images is to read in said continuous remote images from a video-capturing tool via a network based on an instruction embedded in a web page.

3. The method of claim 1, wherein the oldest image of said continuous remote images is covered and replaced by the newest image of said continuous remote images.

4. A system for displaying remote images, wherein said system is installed on a network and comprises:
at least one video-capturing tool connected to said network, wherein said at least one video-capturing tool captures a plurality of images in accordance with a time sequence;
at least one screen used for providing a total display area; and
a video-processing apparatus receiving said images via said network, wherein said video-processing apparatus divides said total display area into a predetermined number of individual display areas, and displays said images respectively on said individual display areas in accordance with said time sequence.

5. The system of claim 4, wherein the oldest image of said images is covered and replaced by the newest image of said images.

6. The system of claim 4, wherein said video-capturing tool comprises a file-providing interface, and receives an instruction via said file-providing interface, and said video-capturing tool divides said total display area into said individual display areas and displays said images respectively on said individual display areas based on the contents of said instruction.

7. The system of claim 4, further comprising a file server connected to said network, wherein said video-processing apparatus reads in an instruction from said file server, and said video-processing apparatus divides said total display area and displays said images on said individual display areas based on the contents of said instruction.

8. The system of claim 4, wherein said video-processing apparatus comprises an operating system and a processing program, said operating system providing a multi-screens function, said processing program receiving said images and calling said operating system to display said images on said individual display areas in accordance with said time sequence.

9. The system of claim 4, wherein said video-processing apparatus uses a vision scheme to label which area of said individual display areas displays the image of said images taken most closely to the current time.

10. The system of claim 4, wherein a user uses an operation interface to assign a designated video-capturing tool of said at least one video-capturing tools for displaying said images captured by said designated video-capturing tool.

11. The system of claim 10, wherein said video-processing apparatus further provides a continuous mode, and said user selects and switches to said continuous mode via said operation interface, and in said continuous mode, said video-processing apparatus display said images continuously on one of said individual display areas of said screen.

12. The system of claim 11, wherein said video-processing apparatus further provides an automatic-switching scheme for using said individual display areas to show said images respectively if the speed of said network displaying said images is lower than a predetermined value, and otherwise, using said continuous mode to show said images.

13. The system of claim 4, wherein a user uses an operation interface to set said predetermined number for dividing said individual display areas from said total display area.

14. The system of claim 4, further comprising:
a storage unit used for storing an operating system and a video-processing program, wherein a processing unit reads in and executes said video-processing program, and said video-processing program receives said images via said operating system and a network interface, and divides said total display area into said individual display areas, and shows said images respectively on said individual display areas in accordance with said time sequence.

15. A computer readable medium provided for storing a computer program, wherein a computer processor reads in said computer program from said computer readable medium and executes at least the steps of:
sequentially reading in a plurality of images from a network, wherein said images is obtained by at least one video-capturing tool in accordance with a time sequence, and said video-capturing tool is connected to said network;
dividing a total display area provided by at least one screen into a plurality of individual display areas; and
displaying said images respectively on said individual display areas in accordance with said time sequence.

16. The computer readable medium of claim 15, wherein when a new image of said images is received, said new image is displayed on the individual display area of said individual display areas used by the oldest image of said images shown in said screen.

17. The computer readable medium of claim 15, wherein said computer program is a script program executed in a browser environment.

18. The computer readable medium of claim 15, wherein said video-processing apparatus uses a vision scheme to label which area of said individual display areas displays the image of said images taken most closely to the current time.

19. The computer readable medium of claim 15, further providing an operation interface, so that a user assigns a designated video-capturing tool of said at least one video-capturing tools via said operation interface for displaying said images captured by said designated video-capturing tool.
